(19) United States
(12) Patent Application Publication
(10) Pub. No.: US 2015/0302282 A1
(43) Pub. Date: Oct. 22, 2015

(54) PRINTING APPARATUS AND METHOD OF CONTROLLING PRINTING APPARATUS

(71) Applicant: CANON KABUSHIKI KAISHA, Tokyo (JP)

(72) Inventor: Takashi Osuki, Kawasaki-shi (JP)

(21) Appl. No.: 14/689,353

(22) Filed: Apr. 17, 2015

(30) Foreign Application Priority Data
Apr. 21, 2014 (JP) 2014-087595

(51) Int. Cl. G06K 15/02

(52) U.S. Cl. CPC G06K 15/1806

(57) ABSTRACT

A printing apparatus distinguishes whether image data of a page included in print data is color or monochrome, determines whether image data of a page generated based on print data is color or monochrome, and changes from a color print mode to a monochrome print mode based on a result of the distinguishing and a result of the determination.

### BACKGROUND OF THE INVENTION

1. Field of the Invention

The present invention is related to a printing technique that realizes a monochrome print mode and a color print mode.

2. Description of the Related Art

Even if the main objective of color printing apparatuses is to print color documents, it is not necessarily the case that it is used only for printing color documents; they is also widely used to print monochrome documents. Because such apparatuses are used for printing of mixed documents containing color pages and monochrome pages, and are used for printing in accordance with instructions may by multiple users on a network, the tendency for color documents and monochrome documents to be mixed is becoming stronger.

Among color printing apparatuses, there exists tandem system color printing apparatuses that comprise four developers and photosensitive drums that support each of four colors: cyan, magenta, yellow and black.

Some of these kinds of tandem system color printing apparatuses have a mechanism (for example, causing a photosensitive drum to idle) for operating each unit (yellow, cyan, or magenta) that is not used to print characters during monochrome printing. However, this kind of idling of the photosensitive drums can shorten the life span of the yellow, cyan, and magenta photosensitive drum units more than is necessary.

Therefore, for this type of color printing apparatus, in order to reduce wear of each unit and consumption of toner, switching of operation between color text printing processing and monochrome text printing processing is performed. More specifically, there exist apparatuses wherein when printing a monochrome document, yellow, cyan and magenta developers, or any developer other than black, are separated from an electrostatic conveyance belt, and control is performed such that text printing other than black is not performed.

In other words, in order to prevent the shortening of the life spans of the units for yellow, cyan and magenta, a color printing apparatus in which, in accordance with the content of sent data, a color printing operation, and a monochrome printing operation, wherein yellow, cyan, and magenta developers are evacuated, are switched has been proposed. In this case, when there is only monochrome data in the data that is sent, the apparatus is switched to the monochrome printing operation automatically and printing is performed.

However, due to the difference in the color printing operation and the monochrome printing operation as explained above, when transitioning from the monochrome printing operation to the color printing operation, or when performing the reverse transition, an action for evacuating and recovering developers becomes necessary.

For this reason, when a transition between the monochrome printing operation and the color printing operation occurs, time is required to perform the switching, and printing consecutively cannot be performed. In this way, for conventional printing apparatuses, time is taken when switching between the color printing operation and the monochrome printing operation.

For these reasons, a device is proposed which, in the case of printing when there is a document having a mix of color pages and monochrome pages, according to predetermined conditions, increases throughput by printing monochrome data as is in color without performing a switching of the print operation.

For example, according to Japanese Patent Laid-Open No. H11-34438, switching of a print operation for reasons of throughput is described. In other words, while operating in a color print mode, in the case that an image that is received and which is to be printed next is a monochrome image, print times are compared for a case of printing as is in color print mode and a case of switching to monochrome print mode and printing. The printing apparatus is proposed to then, in the case that a print time can be shortened when printing in the color print mode, print as is in color print mode. However, according to the proposed method, a lot of time is taken when switching from the color print mode to the monochrome print mode. For this reason, in the case that an engine is one in which it is possible to always print faster in color print mode as is without switching, once monochrome data is printed in the color print mode, all monochrome data will be printed in the color print mode. Therefore, there is problem in that the life spans of photosensitive drum units, and the like, are severely shortened for a tandem system printing apparatus.

### SUMMARY OF THE INVENTION

The present invention was conceived in view of these kinds of problems, and provides a print mode switching technique that achieves both throughput of print processing, and life span of a unit within a printing apparatus.

According to the first aspect of the present invention, there is provided a printing apparatus operable to perform a print in a color print mode and to perform a print in a monochrome print mode, the apparatus comprising: a generation unit configured to generate image data based on print data; a distinguishing unit configured to distinguish whether image data of a page included in the print data is color or monochrome; a determination unit configured to determine whether image data of a page generated by the generation unit is color or monochrome; and a change unit configured to change from the color print mode to the monochrome print mode based on a result of the distinguishing by the distinguishing unit and a result of the determination by the determination unit.

According to the second aspect of the present invention, there is provided a method of controlling a printing apparatus operable to perform a print in a color print mode and to perform a print in a monochrome print mode, the method comprising: a generation step of generating image data based on print data; a distinguishing step of distinguishing whether image data of a page included in the print data is color or monochrome; a determination step of determining whether image data of a page generated in the generation step is color or monochrome; and a change step of changing from the color print mode to the monochrome print mode based on a result of the distinguishing in the distinguishing step and a result of the determination in the determination step.

According to the third aspect of the present invention, there is provided a non-transitory computer-readable storage medium storing a program for causing a computer to execute a method of controlling a printing apparatus operable to perform a print in a color print mode and to perform a print in a monochrome print mode, wherein the program causes the computer to execute: a generation step of generating image data based on print data; a distinguishing step of distinguishing whether image data of a page included in the print data is color or monochrome; a determination step of determining whether image data of a page generated in the generation step is color or monochrome; and a change step of changing from the color print mode to the monochrome print mode based on a result of the distinguishing in the distinguishing step and a result of the determination in the determination step.

Further features of the present invention will become apparent from the following description of exemplary embodiments (with reference to the attached drawings).

### BRIEF DESCRIPTION OF THE DRAWINGS

FIG. 1 is a block diagram for showing an example system configuration.

FIG. 2 is a view for illustrating an example of a print mechanism comprised in a printing apparatus 1030.

FIG. 3 is a drawing showing a flow of processing from when print data is received to when a raster image is generated.

FIG. 4 is a flowchart of processing executed by a CPU 1034.

FIG. 5 is a flowchart of processing executed by an engine control unit 1046.

FIG. 6 is a view for explaining a variety of cases that occur for processing in the flowchart of FIG. 5.

### DESCRIPTION OF THE EMBODIMENTS

Embodiments of the present invention will be described hereinafter in detail, with reference to the accompanying drawings. Note that embodiments described below merely illustrate examples of specifically implementing the present invention, and are only specific embodiments of a configuration defined in the scope of the claims.

### First Embodiment

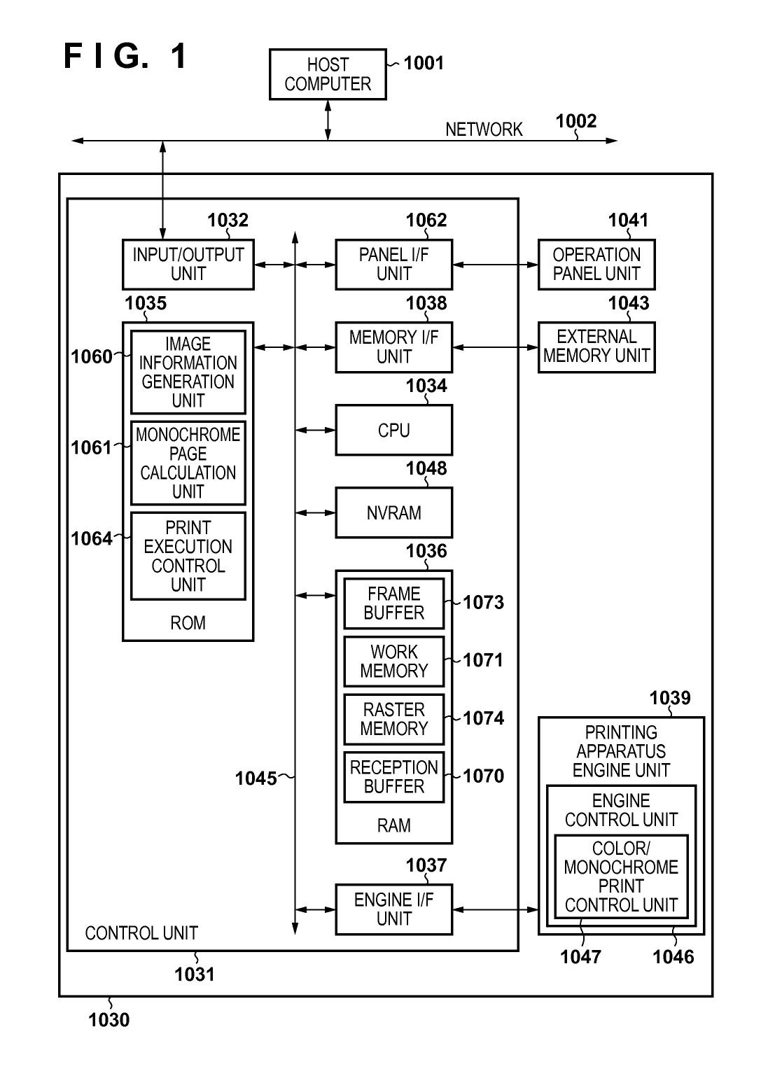

Firstly, an explanation will be given using a block diagram in FIG. 1 for an example configuration of a system including a printing apparatus according to the present embodiment. As shown in FIG. 1, the system comprises a host computer 1001 and a printing apparatus 1030, and the host computer 1001 and the printing apparatus 1030 are connected via a network 1002 which is wireless or wired, such as a LAN.

Firstly, an explanation will be given for the host computer 1001. The host computer 1001 is configured from a general PC (personal computer) or a portable terminal device, and is a device which is capable of making requests to the printing apparatus 1030 for a printing of a page. However, the host computer 1001 transmits printing target page print data (PDL data, image data, or the like) via the network 1002 to the printing apparatus 1030.

Next, an explanation will be given for the printing apparatus 1030. Hereinafter, an explanation will be given for the printing apparatus 1030 as a laser beam printer or a multi-function peripheral that comprises a laser beam printer function, however will be clear from the explanation hereinafter that the printing apparatus 1030 is not limited to this. The printing apparatus 1030 comprises a control unit 1031, an operation panel unit 1041, an external memory unit 1043, and a printing apparatus engine unit 1039.

Firstly, an explanation will be given for the operation panel unit 1041. The operation panel unit 1041, is configured from a touch panel screen, hard keys, or the like, and provides a user interface function operable by a user for inputting various instructions, and a display function capable of displaying various information. The operation panel unit 1041 is connected to the control unit 1031 via a panel I/F (interface) unit 1062.

Next, an explanation will be given for the external memory unit 1043. The external memory unit 1043 is a large capacity information storage device as typified by a hard disk drive device. An OS (operating system), computer programs and data that are employed as appropriate by a CPU 1034 and the printing apparatus engine unit 1039 are saved in the external memory unit 1043. Also, the external memory unit 1043 may be used to store a variety of data temporarily in place of a RAM 1036. The external memory unit 1043 is connected to the control unit 1031 through a memory I/F unit 1038.

Next, an explanation will be given for the control unit 1031.

An input/output unit 1032 is for performing data communication with the host computer 1001 via the network 1002, and for example, is able to receive print data that was transmitted from the host computer 1001.

The CPU 1034 executes processing using a computer program and data stored in a ROM 1035, an NVRAM (non-volatile RAM) 1048, the RAM 1036, the external memory unit 1043, or the like. Through this, in addition to performing overall operation control of the printing apparatus 1030, each process explained later is executed by the CPU 1034.

The NVRAM 1048 is a memory for storing data that needs to be stored even when a power source of the printing apparatus 1030 is disconnected.

The RAM 1036 comprises an area for storing data received through the input/output unit 1032 and computer programs and data loaded from the external memory unit 1043, as well as a work area used upon execution of various processing by the CPU 1034. In other words, the RAM 1036 is able to provide each type of area appropriately. In FIG. 1, as areas that are used for the following processing, a frame buffer 1073, a work memory 1071, a raster memory 1074, and a reception buffer 1070 are specifically shown; however, other areas may also be arranged as appropriate.

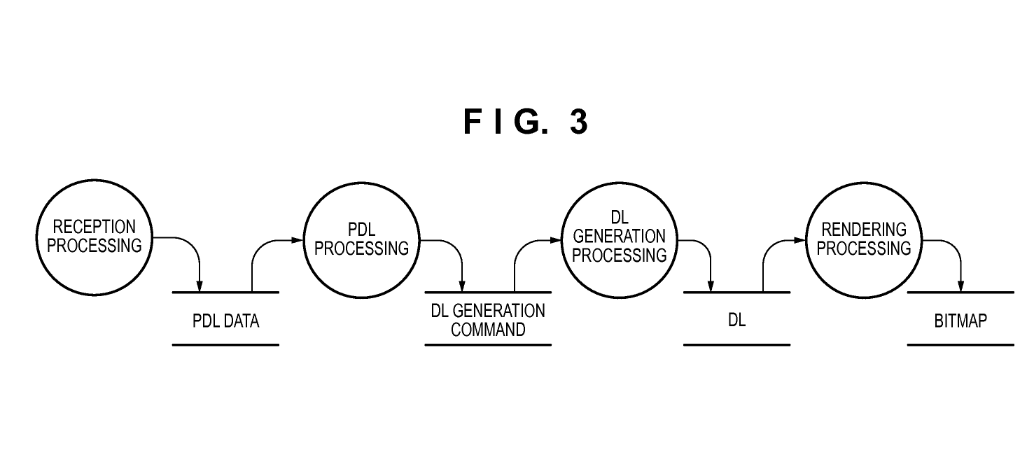

By having the CPU 1034 execute an image information generation unit 1060 that is stored as a computer program within the ROM 1035, the following processing is executed. Firstly, print data received from the host computer 1001 via the input/output unit 1032 is stored in the reception buffer 1070. PDL (Page Description Language) is read out from print data and stored in the work memory 1071, and the PDL is analyzed. This analysis is able to identify whether the page that is a printing target is a color designated page for which color printing is designated, or if it is a monochrome designated page for which monochrome printing is designated. Then, an intermediate code (DL: Display List (also called intermediate data)) is generated from the PDL and stored in the frame buffer 1073. The intermediate code (DL) is data from which a raster image can be generated. Next, the intermediate code (DL) stored in the frame buffer 1073 is expanded into a raster image (bitmap data), and the expanded raster image is stored in the raster memory 1074. It is known that it takes time for the process of expanding from the intermediate code (DL) to the raster image, and it is common to perform this by hardware processing as opposed to software processing. A flow of a processing sequence from when print data is received to when a raster image (bitmap) is generated based on PDL within the print data is shown in FIG. 3.

Additionally, print data is not limited to that which includes PDL; for example, it may also include image data itself; and if the print data is data that causes the printing apparatus 1030 print one or more pages, it can be any kind of data.

Also, by the CPU 1034 executing a monochrome page calculation unit 1061 that is stored within the ROM 1035 as a computer program, a number of consecutive monochrome designated pages are counted, and a process for monochrome pages is executed.

The CPU 1034 executes a print execution control unit 1064 stored in the ROM 1035 as a computer program. Through this, the above described raster image is registered in a queue within the printing apparatus engine unit 1039, and a print execution instruction to the printing apparatus engine unit 1039 is made.

Additionally, computer programs stored within the ROM 1035 are not limited to those described above, and computer programs capable of realizing each later explained process performed by the CPU 1034 and the printing apparatus engine unit 1039 below are also stored.

An engine I/F unit 1037 serves as an interface for connecting the printing apparatus engine unit 1039 to the control unit 1031. The control unit 1031 performs data communication with the printing apparatus engine unit 1039 via the engine I/F unit 1037.

Next, an explanation will be given for the printing apparatus engine unit 1039. The printing apparatus engine unit 1039 comprises the engine control unit 1046, and the engine control unit 1046 further comprises a color/monochrome print control unit 1047.

The engine control unit 1046 is for performing operation control of the printing apparatus engine unit 1039, and performs control of a sequence of printing from sheet feeding of paper to printing and discharging. The color/monochrome print control unit 1047 determines whether a print mode of the printing apparatus 1030 is a color print mode or a monochrome print mode. Then, the color/monochrome print control unit 1047 controls “a print mechanism of the printing apparatus 1030” included in the printing apparatus engine unit 1039 to perform printing in the determined print mode.

Here, a color print mode refers to a print mode that performs printing (color printing) using yellow (Y), magenta (M), cyan (C), and black (K). Also, the monochrome print mode refers to a print mode for performing printing (monochrome printing) using only K.

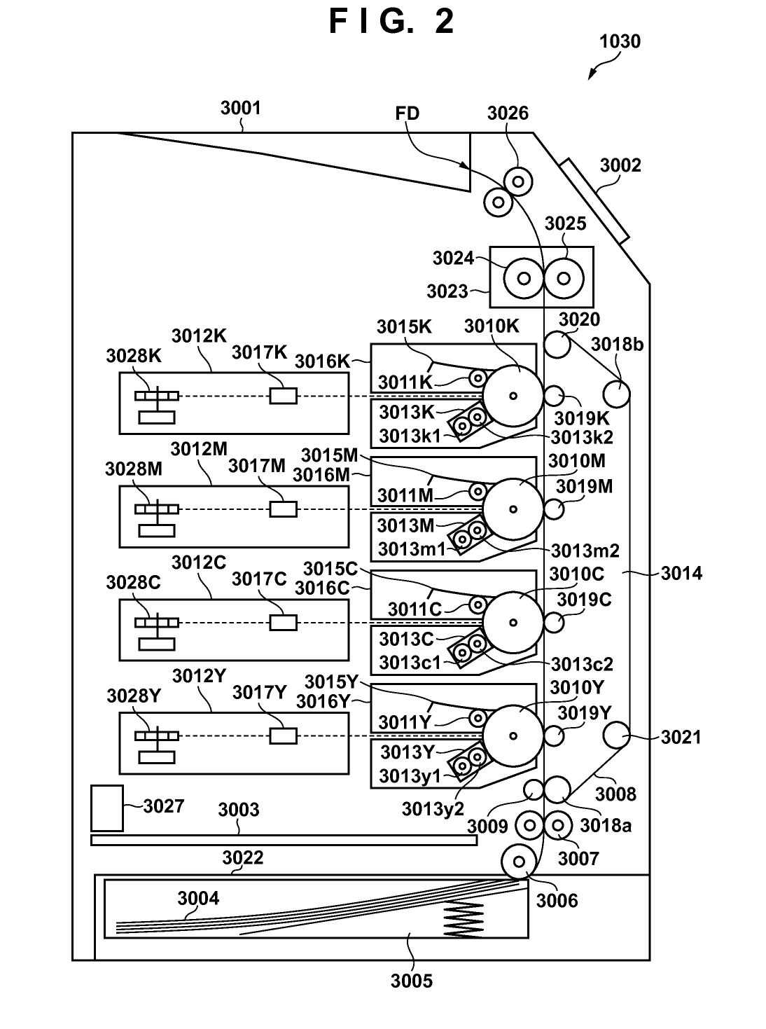

Next, an explanation will be given for an example of a print mechanism that the printing apparatus 1030 comprises using FIG. 2. In FIG. 2, an element that has “C” added to its reference numeral is an element for cyan, and an element that has “M” added to its reference numeral is an element for magenta. An element that has “Y” added to its reference numeral is an element for yellow, and an element that has “K” added to its reference numeral is an element for black.

The printing apparatus 1030, which is a color laser beam printer, is equipped with a housing 3001 as shown in FIG. 2. The housing 3001 has built into it the above described print mechanism, the engine control unit 1046 for performing control for realizing print processing using the print mechanism, and a control board housing unit 3003 for housing the control unit 1031.

The printing apparatus 1030 comprises photosensitive drums 3010 of four image carrying members (3010K, 3010M, 3010C and 3010Y) that are installed in parallel in a perpendicular direction. The photosensitive drums 3010 are rotationally driven in a counter-clockwise direction in FIG. 2 by a driving unit not shown.

The following units are arranged consecutively according to this rotational direction in the periphery of the photosensitive drums 3010. First, charging units 3011 (3011K, 3011M, 3011C and 3011Y) which equally charge the surfaces of the photosensitive drums 3010 are arranged. Also, a laser beam is emitted based on an image information, and scanner units 3012 (3012K, 3012M, 3012C and 3012Y) that form electrostatic latent images on the photosensitive drums 3010 are arranged. Also, developing apparatuses 3013 (3013K, 3013M, 3013C and 3013Y) that cause toner to adhere to the electrostatic latent images to develop toner images are arranged. Also, an electrostatic conveyance transfer apparatus 3014 that transfers the toner images on the photosensitive drums 3010 to a transfer material is arranged. Also, cleaning apparatuses 3015 (3015K, 3015M, 3015C and 3015Y) that remove post transfer toner remaining on the surfaces of the photosensitive drums 3010 post transfer are arranged.

Additionally, the photosensitive drums 3010, the charging units 3011, the developing apparatuses 3013 and the cleaning apparatuses 3015 are integrated as a cartridge. Then, integrated drum type process cartridges 3016 (3016K, 3016M, 3016C, 3016Y) are formed, which are removable from the housing 3001. Next, an explanation will be given for a configuration of each unit in turn.

The photosensitive drums 3010 are configured to circulate an organic photoconductive layer (an OPC photoconductive element). The photosensitive drums 3010 are supported to be rotatable by a supporting member on both ends, and by having a driving force be transferred from a drive motor (not shown) to one edge portion, the photosensitive drums 3010 are rotationally driven counterclockwise as in the figure. Each of the charging units 3011 is a conductive roller formed in a roller shape, and these rollers are made to contact the surfaces of the photosensitive drums 3010. In conjunction with this, by applying a charge bias voltage to these rollers through a power supply (not shown), the photosensitive drums 3010 surfaces are uniformly charged. Scanner units 3012 are arranged in a horizontal direction in relation to the photosensitive drums 3010. Image light that corresponds to an image signal due to a laser diode (not shown) is irradiated on polygon mirrors 3028 (3028K, 3028M, 3028C and 3028Y) that are rotated at high speed by scanner motors. Configuration is such that image light that reflects off of the polygon mirrors 3028 selectively exposes the surfaces of the photosensitive drums 3010 that have been charged through image forming lenses 3017 (3017K, 3017M, 3017C and 3017Y) and form electrostatic latent images.

The developing apparatuses 3013 (3013K, 3013M, 3013C and 3013Y) are configured from developers that each house either a yellow, cyan, magenta, or black color toner in order starting from an upstream side (the bottom side in the figure) of a conveyance direction of the transfer material.

During development of the electrostatic latent images on the photosensitive drums 3010, toner inside a container of a corresponding developer is sent by a sending mechanism to a coating roller 3013k1, 3013m1, 3013c1 or 3013y1. Then, a thin layer of toner is coated on an outer circumference of a rotating developing roller 3013k2, 3013m2, 3013c2 or 3013y2, and additional charge is applied to the toner (frictional electrification).

By applying a developing bias between these developing rollers and the photosensitive drums 3010 on which the electrostatic latent images are formed, toner images are developed by causing toner to adhere to the electrostatic latent images.

After toner that was developed on the photosensitive drums 3010 by the developing apparatuses 3013 has been transferred to the transfer material, the cleaning apparatuses 3015 remove so-called remaining transfer toner that was not transferred and remains on the surface of the photosensitive drums 3010.

An electrostatic conveyance belt 3008 that acts as a belt component is arranged so as to move cyclically while abutting all of the photosensitive drums 3010K, 3010M, 3010C and 3010Y.

The electrostatic conveyance belt 3008 is supported in a perpendicular direction on 4 axis by rollers, and on the outer circumferential face of the left side in the figure, and the electrostatic conveyance belt 3008 on a left-side (in the figure) outer circumferential face electrostatically absorbs transfer material, and to moves cyclically such that the transfer material is brought into contact with the photosensitive drums 3010 described above. Also, an absorption roller 3009 abuts an upstream side in the conveyance direction of a transfer material (bottom side in the figure) of the electrostatic conveyance belt 3008.

A bias voltage is applied to the absorption roller 3009 upon conveyance of a transfer material. With this, a configuration is taken such that an electric field is formed between an attached driven roller 3018a, and a charge polarization is generated between the transfer material and the electrostatic conveyance belt 3008 making it possible for electrostatic absorbability to occur on both.

With this, the transfer material is conveyed to a transfer position by the electrostatic conveyance belt 3008, and the toner images on the photosensitive drums 3010 are transferred successively. Transfer rollers 3019 (3019K, 3019M, 3019C, and 3019Y) that abut an inside (back surface side) of the electrostatic conveyance belt 3008, and that correspond to the four photosensitive drums 3010K, 3010M, 3010C and 3010Y are installed in parallel as transferring members.

A power supply for transfer biasing (not shown) is connected to the transfer rollers 3019. The transfer rollers 3019 oppose the photosensitive drums 3010 and form transfer units. An electric charge of positive polarity from the transfer rollers 3019 is applied to a transfer material through the electrostatic conveyance belt 3008, and by an electric field due to the electric charge, a toner image of negative polarity on the photosensitive drums 3010 is transferred to the transfer material which is in contact with the photosensitive drums 3010.

The electrostatic conveyance belt 3008 is passed along by four rollers: a driving roller 3020, driven rollers 3018a and 3018b, and a tension roller 3021, which rotate in a clockwise direction in FIG. 2. With this, toner images on the photosensitive drums are transferred while the electrostatic conveyance belt 3008 described above moves cyclically, and the transfer material is conveyed from a side of the driven roller 3018a to a side of the driving roller 3020.

A feeding unit 3022 feeds a transfer material to the image forming unit, and a plurality of transfer materials 3004 are housed in a feeding cassette 3005. A feeding roller 3006 (half-moon roller) and a registration roller pair 3007 rotate driving in response to an image forming operation when image forming. Then, the transfer material in the feeding cassette 3005 is fed separately one sheet at a time, and after the leading edge of the transfer material hits the registration roller pair 3007, it stops temporarily, and after a loop is formed, the transfer material is re-fed to the electrostatic conveyance belt 3008.

A fixing unit 3023 causes a plurality of transferred toner images to be fixed to the transfer material, and comprises a heating roller 3024 for rotation driving, and a pressure roller 3025 for pressing and applying heat and pressure to the transfer material.

Thus, the transfer material, to which the toner images on the photosensitive drums 3010 are transferred, is conveyed by the fixing roller pair, and when it passes through the fixing unit 3023, heat and pressure is applied by the fixing roller pair (3024, 3025). With this, a multicolor toner image is fixed on a surface of the transfer material.

Also, process cartridges 3016Y, 3016M and 3016C, whose colors are yellow, magenta, and cyan, are moved from a state in which the photosensitive drums 3010Y, 3010M and 3010C about the electrostatic conveyance belt 3008 to the left direction by an elevating mechanism. Configuration is taken such that the process cartridges 3016Y, 3016M and 3016C can be moved to positions separated from the electrostatic conveyance belt 3008.

Configuration is taken such that the elevating mechanism is operated in accordance with the print mode (color print mode, monochrome print mode) of the printing apparatus 1030. Thus, in a case where the color print mode is designated in the color/monochrome print control unit 1047, the photosensitive drums 3010Y, 3010M and 3010C enter a state in which they abut the electrostatic conveyance belt 3008. Then, by voltage application from each of transfer rollers 3019Y, 3019M, 3019C and 3019K, the toner images of the photosensitive drums 3010 are transferred successively in the order of yellow, magenta, cyan, and black. On the other hand, in a case where the monochrome print mode is designated, by the above described elevating mechanism, the photosensitive drums 3010Y, 3010M and 3010C are separated from the electrostatic conveyance belt 3008. With this, only the photosensitive drum 3010K is in a state in which it abuts the electrostatic conveyance belt 3008, and by voltage application from the transfer roller 3019K, a toner image of the photosensitive drum 3010 is transferred for the color black only.

Note, the color print mode is not necessarily applied to only color designated pages, but it is also applicable to monochrome designated pages, and a toner image is just formed in the color of black, and printing can be performed by the same operation in the color print mode. However, configuration may be taken such that the drum positions of C, M and Y are passed through at high speed in the monochrome print mode in order to be able to perform high speed processing.

In this way, the transfer materials 3004 to which a toner image is transferred are separated from the electrostatic conveyance belt 3008 by the driving roller 3020, and proceed to the fixing unit 3023. Then, after the above described toner image is thermally fixed, the transfer materials 3004 are discharged to a discharge unit FD by a discharging roller pair 3026.

An operation panel 3002 comprised by the operation panel unit 1041 is attached on the housing 3001. On the operation panel 3002, the above described hard keys, an LED display unit for an information display, a touch panel screen, or the like, are arranged. Also, in the housing 3001, an external memory unit 3027 equivalent to the above described external memory unit 1043 is attached.

In this way, the printing apparatus 1030 also operates in the monochrome print mode, and in such a case, the photosensitive drums for yellow, cyan, and magenta separate from the electrostatic conveyance belt. For this reason, contact with the conveyer belt is reduced, and the life span of the photosensitive drums for yellow, cyan, and magenta can be extended. Also, there is a merit that a toner consumption amount is suppressed. However, a touching portion is consumed due to the motor rotating. In a case where the monochrome print is performed in the color print mode, the operation is performed similarly upon operation in the color print mode, and the photosensitive drums of yellow, cyan, and magenta rotate (idle rotation) without printing. For this reason, because of a friction due to contact with the developing apparatuses, removal of unnecessary toner, or the like, the photosensitive drums of yellow, cyan, and magenta will be consumed in conjunction with idle rotation.

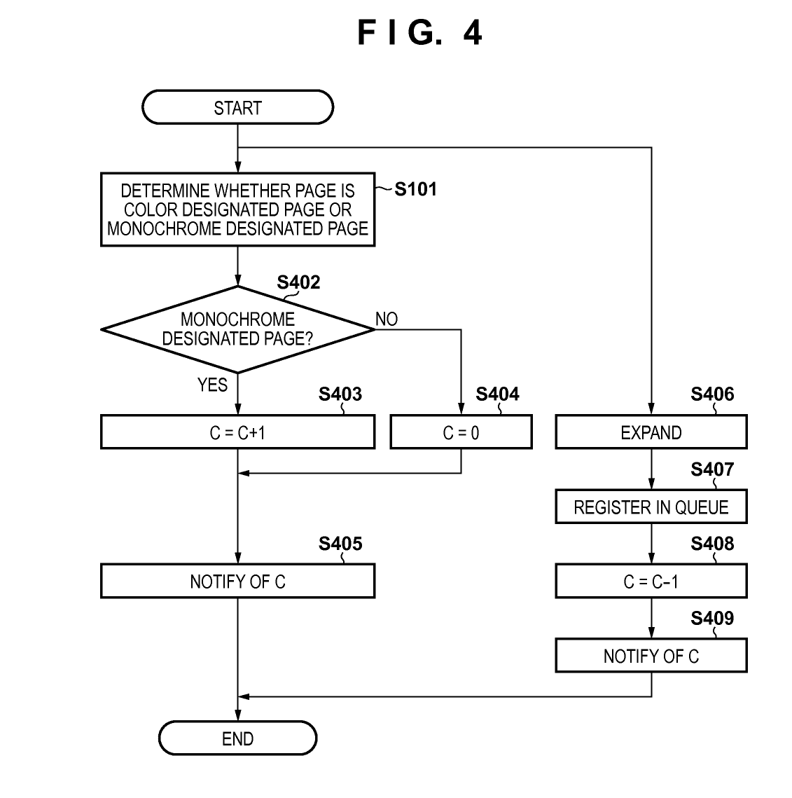

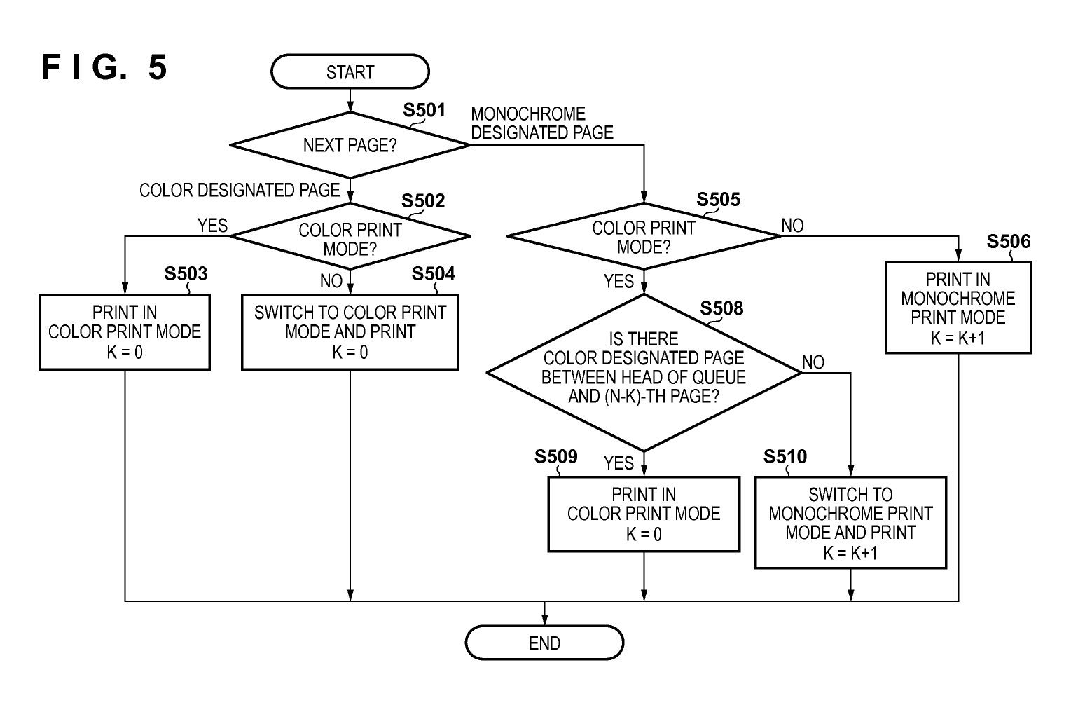

So as to reduce such problems, the printing apparatus 1030 according to the present embodiment operates as follows. Below, explanation will be given for each process performed by the CPU 1034, and the engine control unit 1046 using FIGS. 4 and 5 in a case where print data of plurality of pages is input into the printing apparatus 1030.

First, explanation will be given for the processing performed by the CPU 1034 using a flowchart in FIG. 4. When the CPU 1034 receives print data (unexpanded data) of plurality of pages transmitted from an external apparatus such as the host computer 1001 via the network 1002 and the input/output unit 1032, the CPU 1034 stores the data in the reception buffer 1070 of the RAM 1036. Note, the print data of plurality of pages can be generated in the printing apparatus 1030. For example, print data that a user designated by operating the operation panel unit 1041 for a plurality of pages from the external memory unit 1043 may be used, and print data obtained using a scanner (not shown) may be used.

Also, below, explanation will be given for an operation of the printing apparatus 1030 in a case where print data for plurality of pages exists in the printing apparatus 1030, so there is no need for the print data of plurality of pages to be input at one time. For example, print data for one page may be received from a plurality of transmission sources.

The processing in accordance with the flowchart in FIG. 4 is processing for each page, and in the case of a plurality of pages, the processing in accordance with the flowchart in FIG. 4 is executed for each page.

Also, in the flowchart in FIG. 4, a processing sequence of step S401-step S405 and a processing sequence of step S406-step S409 are executed in parallel and executed asynchronously from each other. Of course these two processing sequences may be executed sequentially.

First, in step S401, the CPU 1034 analyzes print data of a page stored in the reception buffer 1070, and determines whether the page is a color designated page or a monochrome designated page. If the result of the determination is that the page is a color designated page, the processing proceeds to step S404 through step S402, and the processing proceeds to step S403 through step S402 in a case where the page is a monochrome designated page.

In step S403, the CPU 1034 increments a counter value c by one. Note, upon initiation of the processing in accordance with the flowchart in FIG. 4, it is assumed that the counter value c is initialized to 0. On the other hand, in step S404, the CPU 1034 resets the counter value c to 0.

In step S405, the CPU 1034 notifies the counter value c at this point in time to the engine control unit 1046 via the engine I/F unit 1037.

On the other hand, in step S406, the CPU 1034 expands the print data stored in the reception buffer 1070, i.e. unexpanded data, into a raster image. The expansion method differs depending on whether the unexpanded data is the PDL data or another type of data. For example, in a case of the PDL data, as above described, intermediate data is generated from page data stored in the reception buffer 1070 first, and next a raster image of the page is generated using the intermediate data.

In step S407, the CPU 1034 registers page information including the data expanded in step S406 to a queue (not shown) managed by the engine control unit 1046.

In step S408, the CPU 1034 decrements the present counter value c by one (however, only in a case where the counter value c is one or more). In step S409, the CPU 1034 notifies the engine control unit 1046 of the counter value c updated in step S408.

Next, explanation will be given for the processing performed by the engine control unit 1046 using a flowchart in FIG. 5. Note that the processing in accordance with the flowchart in FIG. 5 is processing for each page, and in the case of a plurality of pages, the processing in accordance with the flowchart in FIG. 5 is executed for each page.

In step S501, the engine control unit 1046 refers to “page information of the page (next page) after the present printing page” in the queue, and determines whether the next page is the color designated page or the monochrome designated page. As a result of the determination, in a case of a color designated page, the processing proceeds to step S502, and in a case of a monochrome designated page, the processing proceeds to step S505.

In step S502, the engine control unit 1046 confirms the present print mode, and the processing proceeds to step S503 in a case where the present print mode is the color print mode, and the processing proceeds to step S504 in a case of the monochrome print mode.

In a case of the present embodiment, if the state is such that the photosensitive drums 3010Y, 3010M and 3010C abut the electrostatic conveyance belt 3008, the present print mode can be determined to be the color print mode. Also, if the state is such that the photosensitive drums 3010Y, 3010M and 3010C are separated from the electrostatic conveyance belt 3008, the present print mode can be determined to be the monochrome print mode.

In step S503, the engine control unit 1046 does not perform a change of the print mode, maintains the color print mode, and resets a value of a variable k for counting the number of the monochrome designated pages printed continuously in the color print mode to 0. Note, it is assumed that the value of the variable k is reset to 0 upon activation of the printing apparatus 1030.

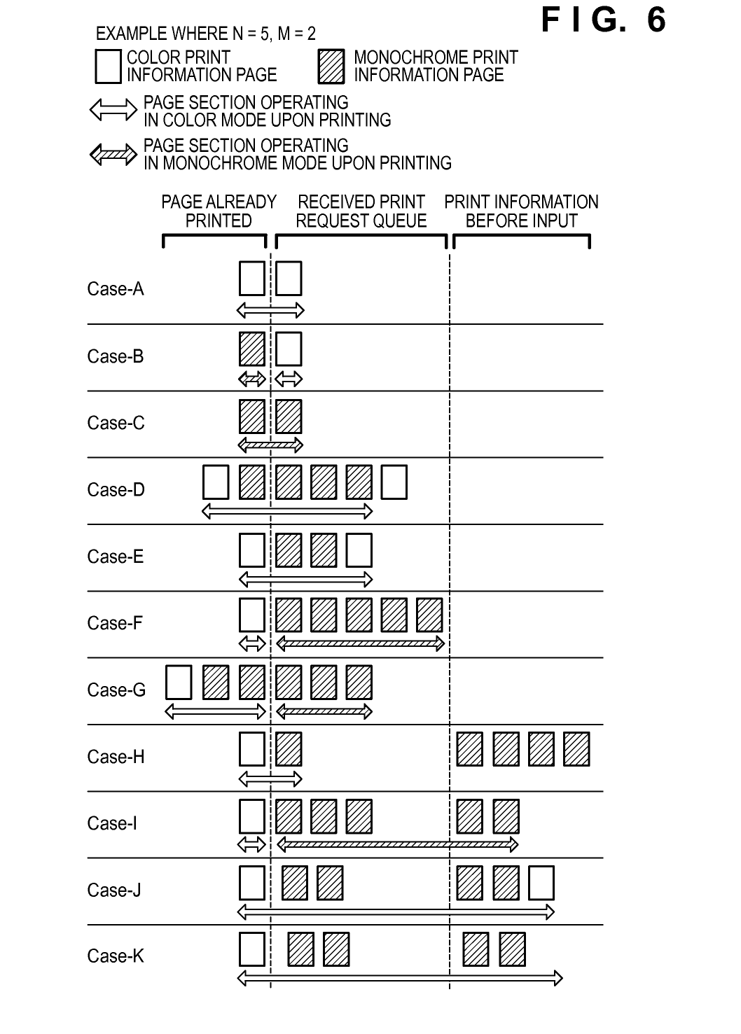

A case of executing the processing in step S503 is illustrated as “Case-A” in FIG. 6. In the “Case-A”, the current printing page is a color designated page and the page to be printed next is also a color designated page. In such a case, the print mode set currently is the color print mode, and printing of the next page to be printed is also designated to be in the color print mode, so the processing in step S503 is performed.

On the other hand, in step S504, the engine control unit 1046 switches the print mode of the printing apparatus 1030 from the monochrome print mode set currently to the color print mode. In addition, in order to perform printing in the color print mode, the “print mechanism of the printing apparatus 1030” included in the printing apparatus engine unit 1039 is controlled. Furthermore, the engine control unit 1046 resets the value of the variable k to 0 in step S504.

A case of executing the processing in step S504 is illustrated as “Case-B” in FIG. 6. In the “Case-B”, the current printing page is a monochrome designated page and the page to be printed next is a color designated page. In such a case, the print mode set currently is the monochrome print mode, and printing of the next page to be printed is designated to be in the color print mode, so the processing in step S504 is performed.

Meanwhile, in step S505, the engine control unit 1046 confirms the present print mode, and the processing proceeds to step S508 in a case where the present print mode is the color print mode, and the processing proceeds to step S506 in a case of the monochrome print mode.

In step S506, the engine control unit 1046 maintains the monochrome print mode without performing a change of the print mode, and increments the value of the variable k by 1. A case of executing the processing in step S506 is illustrated as “Case-C” in FIG. 6. In the “Case-C”, the current printing page is a monochrome designated page and the page to be printed next is a monochrome designated page. In such a case, the print mode set currently is the monochrome print mode, and printing of the next page to be printed is designated to be in the monochrome print mode, so the processing in step S506 is performed.

On the other hand, in step S508, the engine control unit 1046 counts, as a target value, the number of the monochrome designated pages lined up continuously from the head of the queue, in a case where monochrome designated pages and color designated pages are mixed in the queue. Meanwhile, the engine control unit 1046 obtains, as the target value, the total of the number of the monochrome designated pages in the queue and the counter value c recently notified of by the CPU 1034, in a case where only monochrome designated pages are registered in the queue.

Then, if a maximum number of sheets for which monochrome designated pages may be printed in the color print mode continuously is N, the engine control unit 1046 determines whether or not the target value is equal to or larger than (N−k). This is equivalent to determine whether or not a color designated page exists in the pages from the head of the queue to the (N−k)-th page. If the result of the determination is that the target value is equal to or larger than (N−k) the processing proceeds to step S510, and the processing proceeds to step S509 in a case where the target value is less than (N−k).

In step S509, the engine control unit 1046 does not perform a change of the print mode, maintains the color print mode, and resets the value of the variable k for counting the number of the monochrome designated pages printed continuously in the color print mode to 0. Cases of executing the processing in step S509 are illustrated as “Case-D”, “Case-E”, “Case-J”, and “Case-K” in FIG. 6. In FIG. 6, N=5.

In “Case-D”, the current printing page is a monochrome designated page, and from the head of the queue and continuing for three pages are monochrome designated pages. In such a case, the print mode set currently is the color print mode, and the monochrome print mode is designated for a print of the page to be printed next, but the target value (=3)<(N−k)=5−1=4, and so the processing of step S509 will be performed.

Also, in “Case-E”, the current printing page is a color designated page, and from the head of the queue and continuing for two pages are monochrome designated pages. In such a case, the print mode set currently is the color print mode, and the monochrome print mode is designated for a print of the page to be printed next, but the target value (=2)<(N−k)=5−0=5, and so the processing of step S509 will be performed.

Also, in “Case-J”, the current printing page is a color designated page, and from the head of the queue and continuing for two pages are monochrome designated pages, and the counter value c is 2. In such a case, the print mode set currently is the color print mode, and the monochrome print mode is designated for a print of the page to be printed next, but the target value (=4)<(N−k)=5−0=4, and so the processing of step S509 will be performed.

Also, in “Case-K”, the current printing page is a color designated page, and from the head of the queue and continuing for two pages are monochrome designated pages, and the counter value c is 2. In such a case, the print mode set currently is the color print mode, and the monochrome print mode is designated for a print of the page to be printed next, but the target value (=4)<(N−k)=5−0=5, and so the processing of step S509 will be performed.

On the other hand, in step S510, the engine control unit 1046 switches the print mode of the printing apparatus 1030 from the color print mode set currently to the monochrome print mode. In addition, in order to perform printing in the monochrome print mode, the “print mechanism of the printing apparatus 1030” included in the printing apparatus engine unit 1039 is controlled. Furthermore, the engine control unit 1046 increments the value of the variable k by 1 in step S510. Cases of executing the processing of step S510 are shown in FIG. 6 as “Case-F”, “Case-G”, and “Case-I”.

In “Case-F”, the current printing page is a color designated page, and from the head of the queue and continuing for five pages are monochrome designated pages. In such a case, the print mode set currently is the color print mode, and the monochrome print mode is designated for a print of the page to be printed next, and the target value (=5)=(N−k)=5−0=5, and so the processing of step S510 will be performed.

In “Case-G”, the current printing page is a monochrome designated page, and from the head of the queue and continuing for three pages are monochrome designated pages. In such a case, the print mode set currently is the color print mode, and the monochrome print mode is designated for a print of the page to be printed next, and the target value (=3)=(N−k)=5−2=3, and so the processing of step S510 will be performed.

Also, in “Case-I”, the current printing page is a color designated page, and from the head of the queue and continuing for three pages are monochrome designated pages, and the counter value c is 2. In such a case, the print mode set currently is the color print mode, and the monochrome print mode is designated for a print of the page to be printed next, and the target value (=5)=(N−k)=5−0=5, and so the processing of step S510 will be performed.

In this way, in the present embodiment, explanation was given for one example of a printing apparatus comprising a printing unit for performing printing in accordance with a print mode set from out of a color print mode and a monochrome print mode. The printing apparatus explained in the first embodiment is merely one example of the configuration explained below.

In other words, each time unexpanded page data is obtained, it is determined whether the page is a color designated page for which color printing is designated or a monochrome designated page for which monochrome printing is designated. In a case where the page is a monochrome designated page, the printing unit is notified of a numerical value which indicates what page of the pages determined to continuously be monochrome designated pages that page is (a first notification).

Also, each time unexpanded page data is obtained, the data is expanded and registered in the queue, and the numerical value recently notified of in the first notification is decremented by one, and the printing unit is notified of the result (the second notification).

In this kind of the configuration, the printing unit controls as follows in a case where monochrome designated pages and color designated pages are mixed in the queue. The printing unit obtains, as a target value, the total of the number of monochrome designated pages lined up continuously from the head of the queue, the number of the monochrome designated pages in the queue in a case where only monochrome designated pages are registered in the queue, and the numerical value most recently notified of. Then, the printing unit controls as follows in a case where the color print mode is set and the page to be printed next to the present printing page is a monochrome designated page. The printing unit sets the monochrome print mode as the print mode of the printing apparatus if the target value is equal to or larger than a remaining value after subtracting a management value managed as the number of monochrome designated pages printed continuously from a predetermined value.

### Second Embodiment

A variety of approaches can be considered for a print mode switching condition in the printing apparatus 1030 other than the switching approach explained in the first embodiment. For example, if a value set in advance as the number of pieces consecutively printable is M, first the target value is obtained in step S508 similarly to in the first embodiment, and it is determined whether or not the obtained target value is less than M, and in a case where the target value<M, the processing proceeds to step S509. In other words, in a situation where the printing apparatus engine unit 1039 cannot continue continuous printing, the counter value c notified of by the CPU 1034 is not referenced. A case of performing such processing is illustrated as “Case-H” in FIG. 6. In FIG. 6, M=2.

In “Case-H”, the current printing page is a color designated page, and one page at the head of the queue is a monochrome designated page. In such a case, the print mode set currently is the color print mode, and the monochrome print mode is designated for a print of the page to be printed next. Here, the target value (=1)<M (=2), so the printing is performed in the color print mode without performing the switching of print mode.

On the other hand, in a case where the target value is equal to or larger than M, similarly to the first embodiment, it is further determined in step S508 whether or not the target value is equal to or larger than (N−k), and from there the processing is the same with the first embodiment.

### Third Embodiment

In the first and second embodiments, color designated pages are assumed to be pages designated to be printed in color. A “page designated to be printed in color” may be any of the following. The page may be such that the “page is a color page, and as a result of analyzing of color information of the page, it is determined that the page be printed in color, so it is designated that the page is printed in color”. Alternatively, the page may be such that “regardless of whether the page is a color page or a monochrome page, the print settings set for the page or for a sequence of pages including the page designate color printing, and so it is designated that the page be printed in color”.

This is the same for a monochrome designated page; a monochrome designated page is a page designated to be printed in monochrome. A “page designated to be printed in monochrome” may be any of the following. The page may be such that the “page is a monochrome page, and as a result of analyzing of color information of the page, it is determined that the page be printed in a monochrome print, so it is designated that the page is printed in monochrome”. Alternatively, the page may be such that “regardless of whether the page is a color page or a monochrome page, the print settings set for the page or for a sequence of pages including the page designate a monochrome print, and so it is designated that the page be printed in monochrome”.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-087595, filed Apr. 21, 2014, which is hereby incorporated by reference herein in its entirety.

What is claimed is:

1. A printing apparatus operable to perform a print in a color print mode and to perform a print in a monochrome print mode, the apparatus comprising:
a generation unit configured to generate image data based on print data;
a distinguishing unit configured to distinguish whether image data of a page included in the print data is color or monochrome;
a determination unit configured to determine whether image data of a page generated by the generation unit is color or monochrome; and
a change unit configured to change from the color print mode to the monochrome print mode based on a result of the distinguishing by the distinguishing unit and a result of the determination by the determination unit.

2. The printing apparatus according to claim 1,
further comprising a storage unit configured to store the print data,
wherein the distinguishing unit, based on the print data stored in the storage unit, distinguishes whether the image data of the page included in the print data is color or monochrome.

3. The printing apparatus according to claim 2,
wherein the distinguishing unit distinguishes whether the image data of the page included in the print data is color or monochrome based on whether a color print is designated or whether a monochrome print is designated for the page included in the print data stored in the storage unit.

4. The printing apparatus according to claim 1,
further comprising a storage unit configured to store the image data of the page generated by the generation unit,
wherein the determination unit determines whether the image data of the page generated by the generation unit is color or monochrome.

5. The printing apparatus according to claim 1, wherein the change unit changes from the monochrome print mode to the color print mode when, in a state in which printing is performed in the monochrome print mode, image data of a page to be printed next is color.

6. The printing apparatus according to claim 1,
further comprising a reception unit configured to receive print data from an external apparatus,
wherein the generation unit generates the image data based on the print data received by the reception unit.

7. A method of controlling a printing apparatus operable to perform a print in a color print mode and to perform a print in a monochrome print mode, the method comprising:
a generation step of generating image data based on print data;
a distinguishing step of distinguishing whether image data of a page included in the print data is color or monochrome;
a determination step of determining whether image data of a page generated in the generation step is color or monochrome; and
a change step of changing from the color print mode to the monochrome print mode based on a result of the distinguishing in the distinguishing step and a result of the determination in the determination step.

8. A non-transitory computer-readable storage medium storing a program for causing a computer to execute a method of controlling a printing apparatus operable to perform a print in a color print mode and to perform a print in a monochrome print mode, wherein
the program causes the computer to execute:
a generation step of generating image data based on print data;
a distinguishing step of distinguishing whether image data of a page included in the print data is color or monochrome;
a determination step of determining whether image data of a page generated in the generation step is color or monochrome; and
a change step of changing from the color print mode to the monochrome print mode based on a result of the distinguishing in the distinguishing step and a result of the determination in the determination step.
